(19) United States
(12) Patent Application Publication
(10) Pub. No.: US 2007/0188299 A1
(43) Pub. Date: Aug. 16, 2007

(54) INTEGRATED INTERPHONE AND RFID ACCESS CONTROL ENCODER

(75) Inventor: Remi David Blum, Holon (IL)

Correspondence Address: SIMON KAHN;c/o LANDONIP, INC, 1700 DIAGONAL ROAD, SUITE 450, ALEXANDRIA, VA, 22314-2866, US

(73) Assignee: IMMOTEC SECURITY SYSTEMS LTD., Holon (IL)

(21) Appl. No.: 11/627,973

(22) Filed: Jan. 28, 2007

Related U.S. Application Data
(60) Provisional application No. 60/762,900, filed on Jan. 30, 2006.

(51) Int. Cl. G05B 19/00

(52) U.S. Cl. 340/5.25; 340/10.51; 379/167.01; 340/5.61; 235/439

(57) ABSTRACT

An interphone panel for a multiple dwelling building operable to control access and encode replacement keys, the interphone panel comprising: a controller; a proximity key tag reader/encoder responsive to the controller; and an interphone voice path responsive to the controller, the interphone voice path creating a voice path between a user and a dweller of the multiple dwelling building, the controller being operative to encode a proximity key tag via the proximity key tag reader/encoder with at least one of building information, dwelling information and key code information.

### BACKGROUND OF THE INVENTION

The invention relates generally to the field of proximity access control for dwellings and in particular to an interphone having an integrated RFID proximity reader and encoder.

Proximity key tags, also known as key fobs, are gaining in popularity for use in access control. Proximity key tags typically operate via radio frequency identification, or RFID, and are covered under a number of international standards such as ISO 14443 and ISO 15693 published by the International Organization for Standardization, Geneva, Switzerland the entire contents of both of which are incorporated herein by reference. One use for proximity key tags is to control access to multiple dwelling buildings, in which each dwelling in the multiple dwelling building is supplied with a plurality of proximity key tags, typically one proximity key tag per dweller.

An interphone is an intercommunicating telephone used to communicate among dwellings in a multiple dwelling building. An interphone typically further provides an access control function, by allowing communication from outside the multiple dwelling building with a dweller. The dweller, after communicating with a person requesting entry, may provide entry via a remote unlocking mechanism integrated with the interphone. An interphone system may further be provided with a proximity key tag access control system thereby providing keyless access for dwellers, and interphone based access for visitors.

A proximity key tag system must provide for replacement key tags in the event of a lost key. Preferably, each dwelling in the multiple dwelling unit should be provided with key tags coded to indicate the dwelling to which it belongs, so as to enable security tracking, controlled access, and ease of replacement and cancellation in the event of a change in tenancy. Furthermore, preferably each dweller of each dwelling is provided with a separately identified key tag, so that replacement and cancellation of a lost or misplaced key tag of one dweller does not inconvenience other dwellers of the dwelling.

Proximity key tag systems are provided with key tag encoders, which are typically attached to a computer, with the computer and key tag encoder being secured typically in a manager's office. Unfortunately in a multiple dwelling unit frequent replacement of lost key tags is required, and the need to obtain access to the secured facility containing the computer and key tag encoder becomes unwieldy.

There is thus a long felt need for an improved controlled access system providing for ease of replacement for lost key tags.

### SUMMARY OF THE INVENTION

Accordingly, it is a principal object of the present invention to overcome the disadvantages of prior art controlled access systems. This is provided in the present invention by an interphone panel having associated therewith a controlled access proximity key tag reader/encoder. The interphone panel is further supplied with a display, and a keypad, the keypad being useable by authorized personnel to enter commands thereby encoding replacement key tags via the associated key tag encoder.

The key tags of a multiple dwelling building are preferably each encoded with dwelling number information. In one embodiment the dwelling number information comprises a numeric code corresponding to the dwelling number, and in another embodiment one or more names are associated with the dwelling and stored with the numeric code or in place of the numeric code.

Preferably, in a multiple dwelling building in which the invention is provided, each key tag belonging to a specific dwelling is provided in one of a plurality of pre-determined colors. Thus, each key tag of each specific dwelling is visibly encoded via a color. Further preferably, the colors are selected in the order of the rainbow, specifically blue, green, yellow, orange and red. In the event that additional key tags are required, a bi-color key tag having one of the above colors with a secondary color, such as grey, is provided.

Preferably, the key tags are further encoded with a date, and further preferably a time, of encoding. The access control system associates the latest date and optionally time with the replacement key tag code, thereby disabling old key tags. Further preferably, when presented with a disabled key tag, the system is operative to erase all data from the disabled key tag.

In a preferred embodiment each key tag in the system is further used as a system backup, by having the building code stored thereon by the key tag encoder. Thus, in the event of a replacement of a part of the system, the system self uploads from the key tag.

In one embodiment a transfer key tag is provided, the transfer key tag storing a complete set of information stored in the interphone panel. The transfer key tag can thus be used as a back-up for the system, or to copy all the key code and dwelling information for transfer to a management station. In another embodiment the key tags are used to load the interphone panel with dweller information.

The invention provides for an interphone panel for a multiple dwelling building operative to control access and encode replacement keys, the interphone panel comprising: a controller; a proximity key tag reader/encoder responsive to the controller; and an interphone voice path responsive to the controller, the interphone voice path creating a voice path between a user and a dweller of the multiple dwelling building, the controller being operative to encode a proximity key tag via the proximity key tag reader/encoder with at least one of building information, dwelling information and key code information.

In one embodiment the interphone panel further comprises a keypad associated with the controller, the controller being operative to encode the proximity key tag responsive to a pre-determined code entered via the keypad. In one further embodiment the interphone panel comprises an electronically controlled lock responsive to the controller, the controller allowing building access via the electronically controlled lock.

In one embodiment the interphone panel further comprises a database associated with the controller, the database comprising building information, dwelling information, key code information, and date stamp information, the date stamp information being associated with the key code information, the controller being further operative to encode the proximity tag with the date stamp information. Preferably, the key code information is associated with a unique key color. Further preferably, the unique key color is selected from among blue, green, yellow, orange and red. In one further embodiment the controller is further operative to read at least one of building information, dwelling information, key code information and date stamp information from a key tag sensed in proximity to the proximity key tag reader/encoder, and compare the read information with the information on the database. In one yet further embodiment in the event the read date stamp information is newer than the stored date stamp information, the controller is operative to replace the stored date stamp information with the read date stamp information. In another yet further embodiment in the event the read date stamp information is older than the stored date stamp information, the controller is operative to erase at least one of building information, dwelling information and key code information from the key tag. In another further embodiment the controller is operative to store at least one of building information, dwelling information and key code information read from at least one key tag in the database, the stored information being use to restrict access to users of key tags.

In one embodiment the dwelling information comprises one of a plurality of names associated with the dwelling.

Independently, the invention provides for a method of restricting access and encoding key tags, the method comprising: providing an interphone panel having a proximity key tag reader/encoder; and encoding a proximity key tag via the proximity key tag reader/encoder with at least one of building information, dwelling information and key code information.

In one embodiment the method further comprises: receiving a pre-determined code, the encoding being responsive to the received pre-determined code. In one further embodiment the method comprises: allowing access in response to an authorized sensed proximity key tag.

In one embodiment the method further comprises: storing building information, dwelling information, key code information, and date stamp information, the date stamp information being associated with the key code information; and encoding the proximity key tag with the date stamp information. In one further embodiment the key code information is associated with a unique key color. Preferably, the unique key color is selected from among blue, green, yellow, orange and red. In another further embodiment the method comprises: sensing a key tag in proximity to the provided proximity key tag reader/encoder; reading at least one of building information, dwelling information, key code information and date stamp information from the sensed key tag sensed; and comparing the read information with the stored information. In one yet further embodiment, in the event the read date stamp information is newer than the stored date stamp information, replacing the stored date stamp information with the read date stamp information. In another yet further embodiment in the event the read date stamp information is older than the stored date stamp information, erasing at least one of building information, dwelling information and key code information from the sensed key tag. In another further embodiment the method comprises storing at least one of building information, dwelling information and key code information read from at least one key tag, the stored information being use to restrict access to users of key tags.

In one embodiment the dwelling information comprises one of a plurality of names associated with the dwelling.

Independently the invention provides for a method of backing up an interphone panel via at least one key tag, the method comprising: storing building information, dwelling information and key code information on a key tag; in the event of a need to restore information from a key tag; reading the stored building information from the key tag; reading the stored dwelling information from the key tag; and in the event either of the read building information or the dwelling information has not been stored on the interphone panel; and storing at lest one of the read building information and dwelling information on the interphone panel, whereby future key tags are authorized based on the stored information on the interphone panel.

In one embodiment, in the event of a need to restore information from a key tag the method further comprises: reading the stored key code information from the key tag; and in the event the key code information has not been stored on the interphone panel, storing the read key code information on the interphone panel, thereby allowing future access to a key tag having the stored key code information. In one further embodiment the method comprises: in the event the key code information has been stored on the interphone panel, comparing a date stamp of the read stored key code information with the stored key code information, and in the event the date stamp of the stored key code information is older than the read stored key code information, replacing the stored key code information with the read key code information. In one yet further embodiment, in the event the date stamp of the stored key code information is newer than the read stored key code information, erasing the key code information from the key tag.

The invention independently provides for an interphone panel for a multiple dwelling building operable to control access and encode replacement keys, the interphone panel comprising: a controller; a proximity key tag reader/encoder responsive to the controller; and a database associated with the controller, the database comprising building information, dwelling information, key code information, and date stamp information, the date stamp information being associated with the key code information, the controller being further operative to encode the proximity tag with the date stamp information.

In one embodiment the controller is further operative to read at least one of building information, dwelling information, key code information and date stamp information from a key tag sensed in proximity to the proximity key tag reader/encoder, and compare the read information with the information on the database, and in the event the read date stamp information is newer than the stored date stamp information, the controller is operative to replace the stored date stamp information with the read date stamp information, and in the event the read date stamp information is older than the stored date stamp information, the controller is operative to erase at least one of building information, dwelling information and key code information from the key tag.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates an embodiment of a interphone panel exhibiting a key tag reader/encoder, a keypad and a display in accordance with a principle of the invention;

FIG. 2 illustrates a high level block diagram of the interphone panel of FIG. 1 in accordance with a principle of the invention;

FIG. 3 illustrates a high level diagram of a system in accordance with a principle of the invention in which a single portable management computing platform is used to encode key tags, the management computing platform being in communication with the interphone panel to which it is connected;

FIG. 4 illustrates a high level diagram a system in accordance with a principle of the invention in which a plurality of management computing platform are provided for encoding key tags for a plurality of multiple dwelling buildings, each of the buildings being represented by an interphone panel, the network being further provided with a central server;

FIG. 5 illustrates encoding of key tags for each dweller of a dwelling by color in accordance with a principle of the invention;

FIG. 6 illustrates a high level flow chart of the operation of the interphone to allow for programming of new key tags in accordance with a principle of the invention;

FIG. 7 illustrates a high level flow chart of the operation of the interphone to allow for programming of replacement key tags in accordance with a principle of the invention;

FIG. 8 illustrates a high level flow chart of the operation of the interphone panel to allow for restoring the information to the interphone from the key tags in accordance with a principle of the invention; and

FIG. 9 illustrates a high level flow chart of the operation of the interphone panel to control access to a multiple dwelling building and erase information from key tags which have been replaced in accordance with a principle of the invention.

### DETAILED DESCRIPTION OF THE PREFERRED EMBODIMENTS

The present embodiments enable an interphone panel having associated therewith a controlled access proximity key tag reader/encoder. The interphone panel is further supplied with a display, and a keypad, the keypad being useable by authorized personnel to enter commands thereby encoding replacement key tags via the associated key tag encoder.

The key tags of a multiple dwelling building are preferably each encoded with dwelling number information. In one embodiment the dwelling number information comprises a numeric code corresponding to the dwelling number, and in another embodiment one or more names are associated with the dwelling and stored with the numeric code or in place of the numeric code.

Preferably, in a multiple dwelling building in which the invention is provided, each key tag belonging to a specific dwelling is provided in one of a plurality of pre-determined colors. Thus, each key tag of each specific dwelling is visibly encoded via a color. Further preferably, the colors are selected in the order of the rainbow, specifically blue, green, yellow, orange and red. In the event that additional key tags are required, a bi-color key tag having one of the above colors with a secondary color, such as grey, is provided.

Preferably, the key tags are further encoded with a date, and further preferably a time, of encoding. The access control system associates the latest date and optionally time with the replacement key tag code, thereby disabling old key tags. Further preferably, when presented with a disabled key tag, the system is operative to erase all data from the disabled key tag.

In one embodiment a transfer key tag is provided, the transfer key tag storing a complete set of information stored in the interphone pane. The transfer key tag can thus be used as a back-up for the system, or to copy all the key code and dwelling information for transfer to a management station.

In a preferred embodiment each key tag in the system is further used as a system backup, by having the building code stored thereon by the key tag encoder. Thus, in the event of a replacement of a part of the system, the system self uploads from the key tag.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

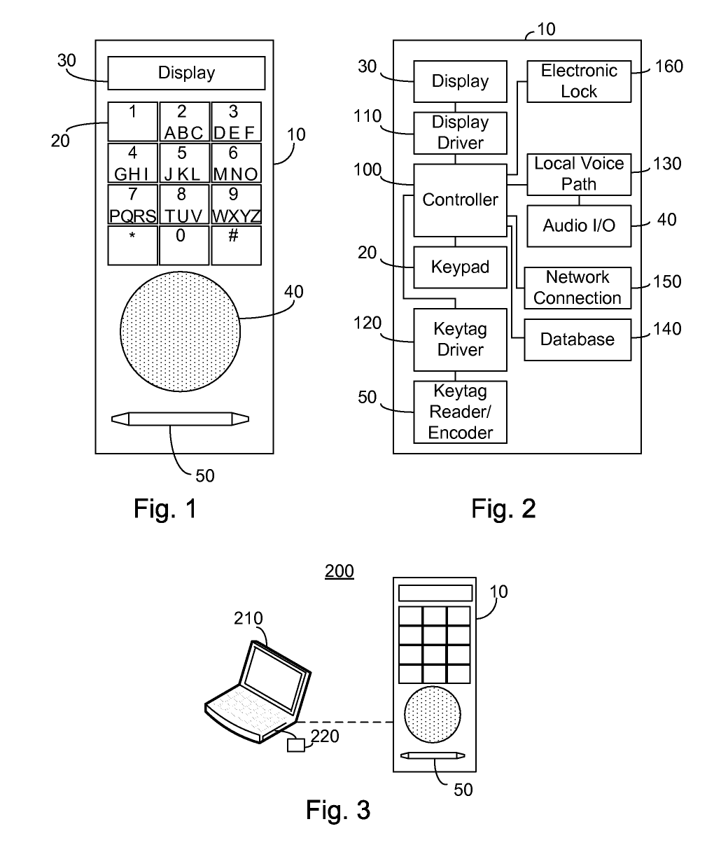

FIG. 1 illustrates an embodiment of a interphone panel 10 exhibiting a keypad 20, a display 30, an audio input/output device 40, and a key tag reader/encoder 50 in accordance with a principle of the invention. Keypad 20 enables a user to selectively connect with a specific dwelling of the multiple dwelling building by inputting a name associated with a specific dwelling. A dweller in the addressed dwelling communicates with the user via the audio input/output device 40 and if so inclined allows entry via remote operation of an electronic lock (not shown) associated with interphone panel 10.

Key tag reader/encoder 50 is operative to read a proximity key tag of an authorized dweller and allow entry by opening the electronic lock associated with interphone panel 10. Each dweller of the multiple dwelling building is provided with a key tag as will be explained further hereinto below, and preferably key tags of each dwelling in the multiple dwelling unit are provided with a key tag coded to indicate the dwelling to which it belongs, so as to enable security tracking, controlled access, and ease of replacement and cancellation in the event of a change in tenancy. Furthermore, each dweller of each dwelling is provided with a separately identified key tag, so that replacement and cancellation of a lost or misplaced key tag of one dweller does not inconvenience other dwellers of the dwelling. In a preferred embodiment certain key tags associated with a dwelling are further encoded with a name associated with the dwelling. For example, key tags associated with the parents in a family dwelling may be encoded with the parent's name, while key tags of children who would be associated with both of the parent's names may be left without a name encoding.

Interphone 10 is further operative as will be explained further hereinto below, responsive to specific commands received via keypad 20, to program key tags via key tag reader/encoder 50. Thus advantageously interphone 10 allows for convenient replacement of lost keys without requiring the use of a management computing platform and associated key tag encoder. Further advantageously interphone 10 is operative, as will be explained further hereinto below, to recover lost information from the various dweller key tags and disable key tags for which a replacement has been issued.

FIG. 2 illustrates a high level block diagram of interphone panel 10 of FIG. 1 in accordance with a principle of the invention. Interphone panel 10 comprises: a controller 100; a keypad 20; a display driver 110; a display 30; a key tag reader/encoder driver 120; a key tag reader/encoder 50; a local voice path 130; an audio input/output device 40; a database 140; a network connection 150; and an electronic lock 160. Display driver 110 is connected to controller 100 and to display 30. Keypad 20 is connected to controller 100. Key tag reader/encoder driver 120 is connected to controller 100 and to key tag reader/encoder 50. Local voice path 130 is connected to controller 100 and to audio input/output device 40. Database 140, network connection 150 and electronic lock 160 are each connected to controller 100. Key tag reader/encoder 50 and reader/encoder driver 120 are available commercially from many sources including Gemplus International SA of Gemenos, France and Immotec Systems of Paris, France.

Local voice path 130 may comprises a plurality of switched voice connections between audio input/output device 40 and audio input/outputted device local in each dwelling. Alternatively, a single network of addressed encoded voice may be provided. In one embodiment local path 130 represents a voice over Internet protocol path for audio.

Network connection 150, which is optionally provided, provides a connection to management computing platforms and other external database systems. In one embodiment, network connection 150 comprises an Internet connection, and in another embodiment network connection 150 is a connection to a local area network.

Audio input/output device 40 may comprise a telephone handset, or a speaker microphone. In one embodiment, audio input/output device 40 is further provided with a video connection as is described in U.S. Pat. No. 5,612,994 issued Mar. 18, 1997 to Chen, the entire contents of which are incorporated herein by reference.

Database 140 preferably comprises a non-volatile memory such as a flash memory associated with controller 100. The use of a non-volatile memory is preferred so as to avoid loss of memory in the event of a power outage or blackout.

In operation, controller 100, responsive to a pre-determined code input via keypad 20, operates key tag driver 120 to operate key tag reader/encoder 50 in encoding mode. Controller 100 is in communication with database 140 to obtain building code information, dwelling information and optionally dwelling name information to store onto a designated key tag via key tag reader/encoder 50. Any key tag loaded via controller 100 is preferably also communicated via optional network connection 150, further preferably with a time of encoding. The code inserted on the key tag by controller 100 is further stored associated with a date stamp, and optionally a time stamp, on database 140. Controller 100 further operates display driver 110 to display command information on display 30.

In the absence of the pre-determined code, controller 100 operates key tag driver 120 in a reading mode. Key tags sensed by key tag reader/encoder 50 are identified, and compared with authorized key tag information stored on database 140. In the event that the key tag is authorized to allow entry, controller 100 allows access via the operation of electronic lock 160. Controller 100 further operates to control local voice path 130 to enable a voice path for a user who has entered a dwelling name via keypad 20. The voice path is enabled between the user having access to audio input/output device 40 and an audio input/output device associated with the input dwelling. Preferably, the dwelling further has a means of sending a command to controller 100, to enable access to the user via the operation of electronic lock 160. In another embodiment the dwelling is provided with a direct connection to electronic lock 160, bypassing the requirement to send a command to controller 100.

FIG. 3 illustrates a high level diagram of a system 200 in accordance with a principle of the invention in which a management computing platform 220 provided with a key tag encoder 220 is used to encode key tags, management computing platform 210 being in communication with an interphone panel 10 to which it is connected either permanently or temporarily. There is no requirement for a management computing platform 20 to be connected to interphone panel 10, and advantageously interphone panel 10 can be used without any management computing platform 20 since each of the plurality of interphone panels 10 exhibits a key tag reader/encoder 50 operative to read and/or encode key tags as will be described further hereinto below. Communication between management computing platform 210 of system 200 and interphone panel 10 is shown as a direct wired connection, however this is not meant to be limiting in any way. A wireless link, a network connection, or the use of removable memory components such as USB drives, may be utilized without exceeding the scope of the invention.

Management computing platform 210 advantageously allows for encoding and uploading a large plurality of key tags associated with an interphone panel 10. Such a large plurality of key tags is encoded, for example, on initial occupation of a multiple dwelling building. Management computing platform 210 may be loaded off-site with dwellant information, and further exhibits a full keyboard and large display simplifying the task of initial encoding and uploading.

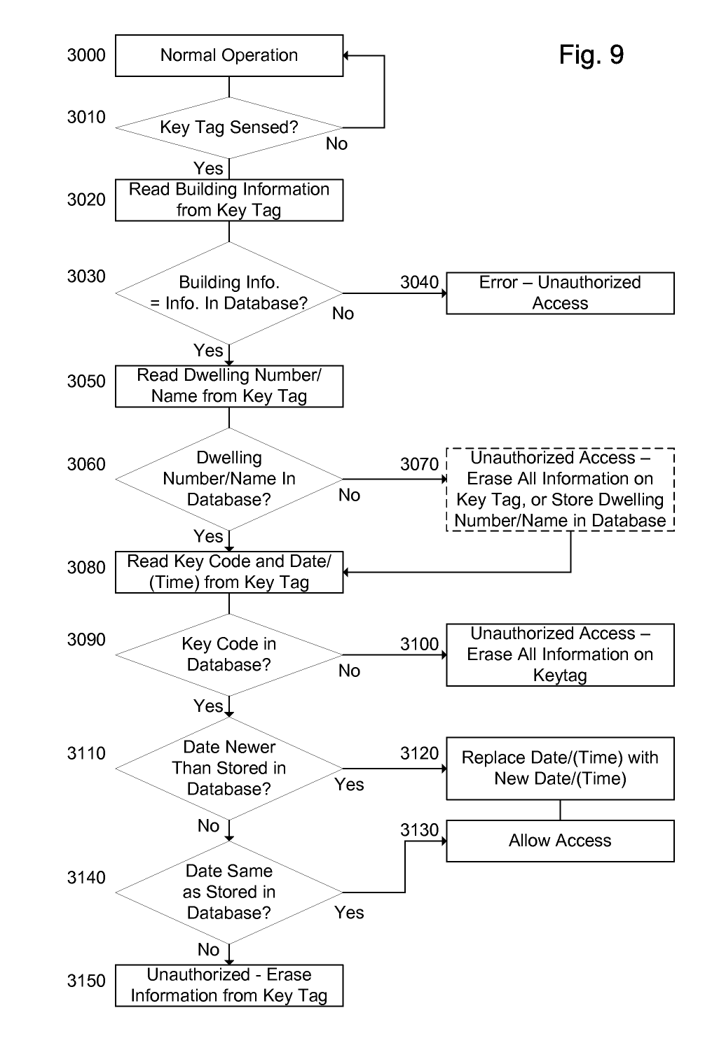

In alternative embodiment, management computing platform 210 is used to encode a large plurality of key tags, and the key tag information is uploaded to interphone panel 10 from the key tags in accordance with method described further hereinto below in relation to FIG. 9. In such an embodiment only the building code need be supplied to the interphone panel on a one time basis, and key tags may be supplied directly to dwellants without requiring on site use of management computing platform 210. It is to be understood that in such an embodiment, which will be explained further hereinto below in relation to FIG. 9, interphone panel 10 learns dwelling numbers and optionally dwellant names from key tags presented with the previously loaded building code.

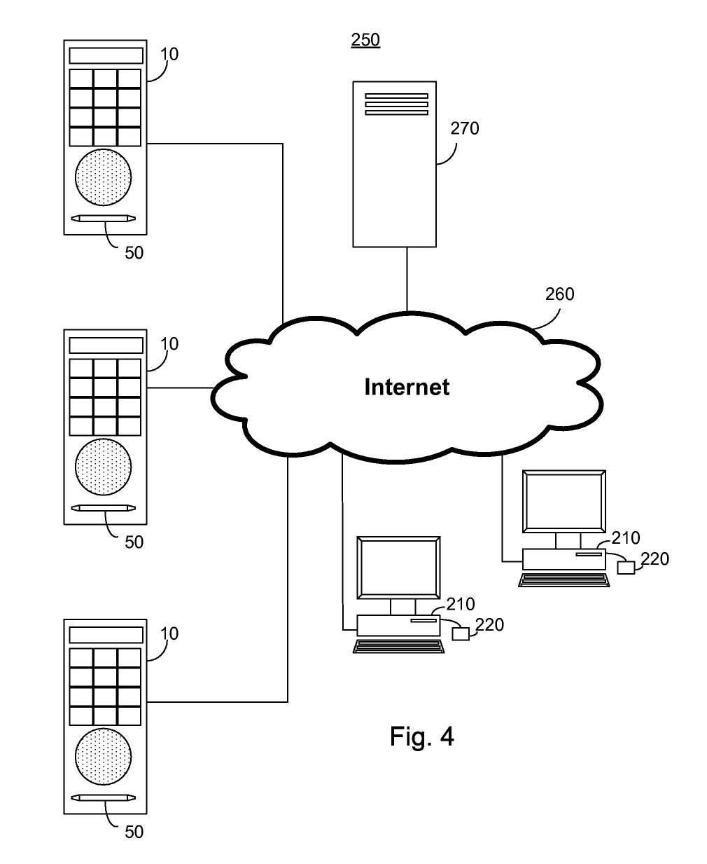

FIG. 4 illustrates a high level diagram a system 250 in accordance with a principle of the invention in which a plurality of management computing platforms 210, each being provided with a key tag encoder 220 for encoding key tags for a plurality of multiple dwelling buildings, each of the buildings exhibiting an interphone panel 10. System 250 is further provided with a server 270 storing thereon a database for all key tags authorized in system 250. Thus, a key tag authorized to access multiple buildings, such a postal employee key tag, is communicated to all interphone panels 10 for which access is to be authorized. Additionally, data regarding key tags encoded at any interphone panel 10 or management computing platform 210 is stored on server 270 as well as the local database maintained by each interphone panel 10.

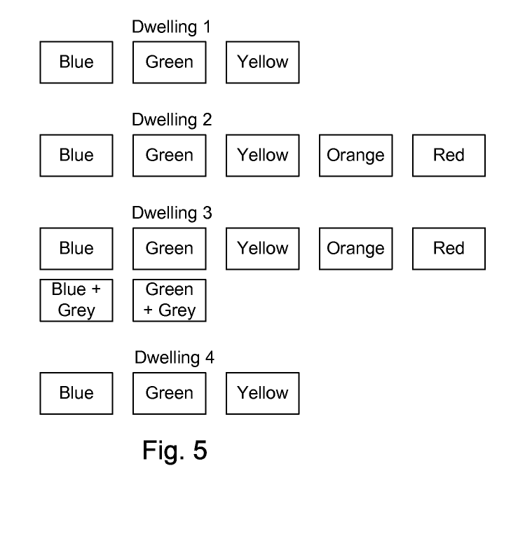

FIG. 5 illustrates encoding of key tags for each dweller of a dwelling by color in accordance with a principle of the invention, in which each block represents a specific key tag of the dwelling. Dwelling 1 is shown having associated therewith 3 key tags, coded respectively as blue, green and yellow. Thus, each occupant of dwelling is issued a key tag of a specific color in place of a numeric code. Such a use of color coding of key tags allows for ease of replacement and cancellation of lost tags, as the user is more apt to recall a color than a numeric code. Furthermore, the keys are advantageously coded in the order of colors of the rainbow, thereby simplifying installation and ease of color recall.

Dwelling 2 is shown having associated therewith 5 key tags, coded respectively blue, green, yellow, orange and red. The colors of the key tags used in dwelling 1 are again issued to dwelling 2, in addition to the balance of the rainbow colors, however the key tags are not interchangeable since the dwelling number is encoded thereon.

Dwelling 3 is shown having associated therewith 7 key tags, in excess of the number of base color codings provided. In order to maintain the simplicity of the color coding system, and ensure ease of recognition, preferably only 5 base colors are used, and a second color is used to identify a second set of up to 5 additional key tags. The key tags of dwelling 3 are shown coded blue, green, yellow, orange, red, blue plus grey, and green plus grey. The key tags encoded with grey preferably have one side colored grey, with an opposing side encoded with the color of identification. Key tags of a single color code are fully colored with the color indicated appearing on all sides of the key tag.

Finally, dwelling 4 is shown having associated therewith 3 key tags, coded respectively as blue, green and yellow. The colors of the key tags used in dwelling 1 are again issued to dwelling 4, however the key tags are not interchangeable since the dwelling number is encoded thereon.

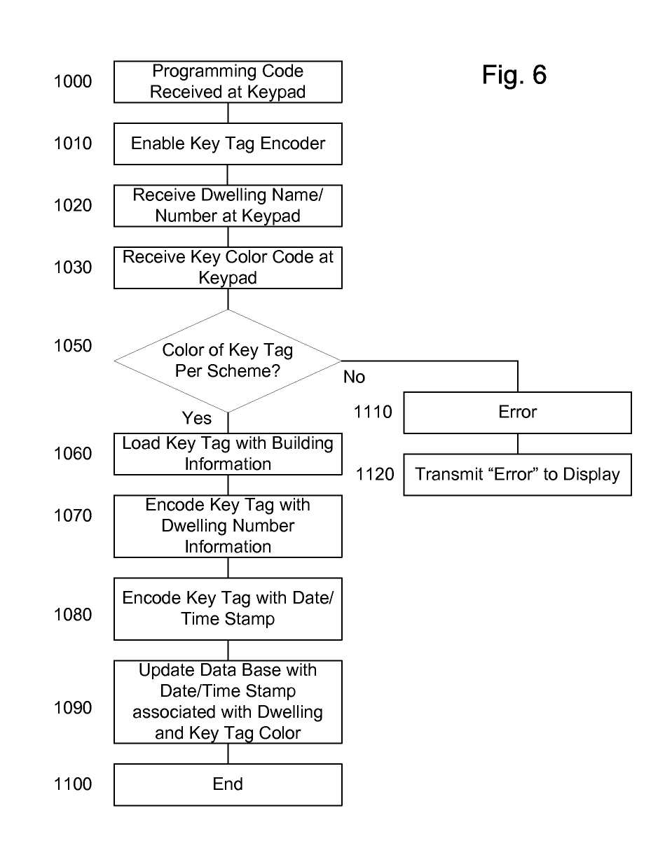

FIG. 6 illustrates a high level flow chart of the operation of the interphone panel to allow for programming of new key tags as described above in accordance with a principle of the invention. In stage 1000, the keypad is operated to input a predetermined new key tag programming code. Preferably, the programming code is restricted to authorized personnel only.

In stage 1010, the key tag reader/encoder, such as key tag reader/encoder 50 of FIG. 2, is enabled. In stage 1020 the dwelling number and preferably the name associated with the key tag to be encoded is received at the interphone panel. In a preferred embodiment, a request for entering the dwelling number or a dwellant name is shown on a display, such as display 30 of FIG. 2, and the dwelling number or dwellant name entered on the key pad in response is also echoed on the display. A dwelling may be associated with one or more dwellant names, typically up to two dwellant names are allowed per dwelling. As indicated above, the interphone panel is loaded with dwellant names to allow for normal interphone communication via an outside user entering the dwellant name.

In stage 1030 the color associated with the key tag to be encoded is received at the interphone panel. In one embodiment the color of the key tag is entered alphabetically using the key pad in response to a request for key color shown on the display. In another embodiment the display shows a numeric code to be entered for each color key tag which may be associated with the dwelling, and the user enters the numeric code associated with the color of the key tag to be encoded. Preferably the choice of colors is selected as described above in relation to FIG. 5, and even further preferably only the next color key tag that may be associated with the dwelling in accordance with the scheme described above in relation to FIG. 5 is displayed, the color being retrieved from the database. In another embodiment, the key tags are encoded with their color prior to being supplied for use, and the reader/encoder reads the color from the key tag and optionally displays the color on the display.

In stage 1050, the key tag color is compared with the list of key tag colors already issued and associated with the dwelling input in stage 1020. In the event that the key tag is not of a color which has already been loaded into the database, and optionally is of the appropriate color as described above in relation to FIG. 5, i.e. it is a key tag according to the color scheme, in stage 1060 building information as stored in the database is loaded onto the key tag via the key tag reader/encoder of the interphone panel. In stage 1070, the dwelling number and/or name as input in stage 1020 is loaded onto the key tag via the key tag reader/encoder of the interphone panel. In stage 1080, the current date, and preferably the time of encoding, is encoded on the key tag. In stage 1090, the database is updated with date and preferably the time of encoding if so encoded, so as to reject any lost key tag. In stage 1100, the routine ends.

In the event that in stage 1050 the key tag is of a color which has already been loaded into the database, or optionally is not of the appropriate color as described above in relation to FIG. 5, i.e. it is not according to the color scheme, in stage 1110 an error is detected, since the key tag which is to be encoded is either a duplicate key or is not of the appropriate color to maintain the scheme of FIG. 5. In stage 1120 an error message is sent to the display of the interphone panel. Preferably the error message indicates the error particulars, either by displaying a phrase such as “duplicate color” or by indicating an error code.

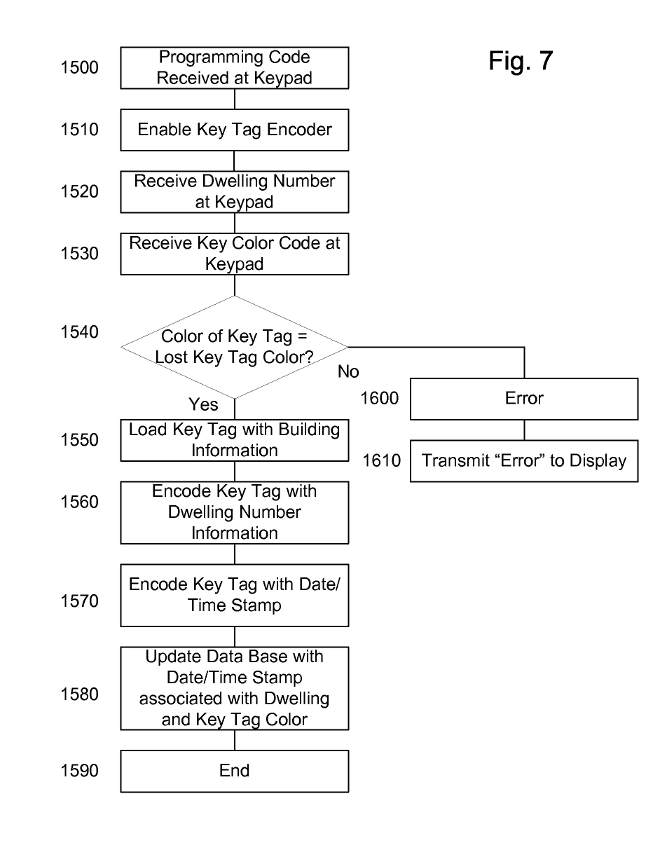

FIG. 7 illustrates a high level flow chart of the operation of the interphone panel to allow for programming of replacement key tags as described above in accordance with a principle of the invention. In stage 1500, the keypad is operated to input a predetermined replacement key tag programming code. Preferably, the programming code is restricted to authorized personnel only.

In stage 1510, the key tag reader/encoder, such as key tag reader/encoder 50 of FIG. 2, is enabled. In stage 1520 the dwelling number and preferably the name associated with the key tag to be encoded is received at the interphone panel. In a preferred embodiment, a request for entering the dwelling number or a dwellant name is shown on a display, such as display 30 of FIG. 2, and the dwelling number or dwellant name entered on the key pad in response is also echoed on the display. A dwelling may be associated with one or more dwellant names, typically up to two dwellant names are allowed per dwelling. As indicated above, the interphone panel is loaded with dwellant names to allow for normal interphone communication via an outside user entering the dwellant name.

In stage 1530 the color associated with the key tag to be replaced is received at the interphone panel. In one embodiment the color of the key tag is entered alphabetically using the key pad in response to a request for key color shown on the display. In another embodiment the display shows a numeric code to be entered for each color key tag associated with the dwelling, and the user enters the numeric code associated with the color of the key tag to be replaced. In another embodiment, the key tags are encoded with their color prior to being supplied for use, and the reader/encoder reads the color from the key tag and optionally displays the color on the display.

In stage 1540, the key tag color is compared with the list of key tag colors already issued and associated with the dwelling input in stage 1520. In the event that the key tag is of a color which has already been issued and is thus in the database, in stage 1550 building information as stored in the database is loaded onto the key tag via the key tag reader/encoder of the interphone panel. In stage 1560, the dwelling number and/or name as input in stage 1520 is loaded onto the key tag via the key tag reader/encoder of the interphone panel. In stage 1570, the current date, and preferably the time of encoding, is encoded on the key tag. In stage 1580, the database is updated with date and preferably the time of encoding if so encoded, so as to reject any lost key tag. In stage 1590, the routine ends.

In the event that in stage 1540 the key tag is of a color which has not been issued, in stage 1600 an error is detected, since the key tag which is to be encoded is not of the same color as the lost key tag. In stage 1610 an error message is sent to the display of the interphone panel. Preferably the error message indicates the error particulars, either by displaying a phrase such as “wrong color” or by indicating an error code.

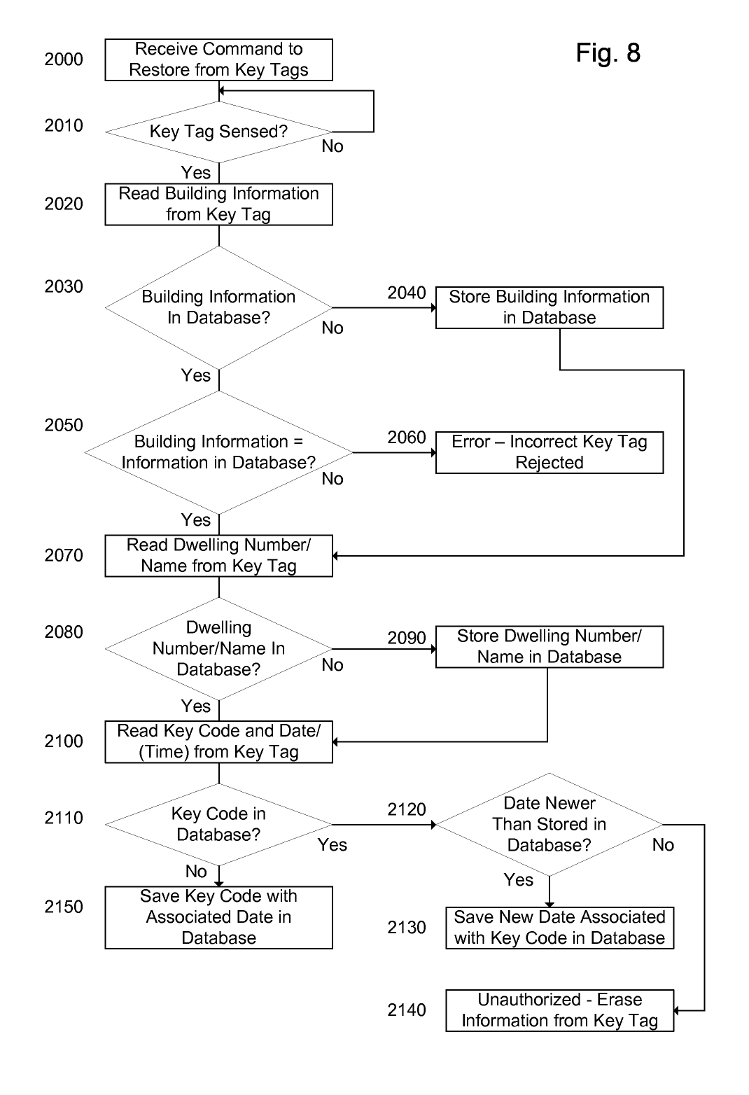

FIG. 8 illustrates a high level flow chart of the operation of an interphone panel in accordance with a principle of the invention to allow for restoring the information to the interphone panel from the key tags. In prior art systems each key tag is given a specific serial code, and the interphone panel recognizes the serial code in accordance with a preloaded database. It is to be noted that key tags in accordance with the subject invention exhibit a memory on which is preferably stored in a password protected area the building code, dwelling information and date/time stamp of creation. Thus, in the event of a failure or replacement of an interphone panel, information may be restored to the interphone panel from the key tags. Date/time stamp information is further used to control access in the event of lost key tags as will be explained further hereinto below.

In stage 2000, a command to perform a system restore from key tags is received at the key pad of the interphone panel. The system restore from key tags command is thus activated by an authorized user. In stage 2010 the interphone panel checks to see whether a key tag has been sensed. In the event that a key tag has not been sensed, stage 2010 is repeated. In the event that in stage 2010 a key tag is sensed, in stage 2020 building information is read from the sensed key tag. Preferably, building information is stored in a password protected area of the key and the interphone panel is supplied with the password. In alternative embodiment, the interphone panel prompts the user, via the display, to supply the password via the keypad.

In stage 2030 the database is queried as to whether building information has already been stored thereon. In the event that building information has not yet been stored in the database, in stage 2040 the building information read in stage 2020 is stored in the database, and preferably a flag is set to indicate that building information has been stored in the database.

In the event that in stage 2030 the results of the inquiry are that building information has already been stored in the database, in stage 2050 the building information read in stage 2020 is compared with the building information stored in the database. In the event that building information read in stage 2020 does not match the building information in the database, in stage 2060 and error condition is displayed on the panel indicating that the key tag does not belong to the building.

In the event that in stage 2050 building information read in stage 2020 matches the building information in the database, or after stage 2040, in stage 2070 the dwelling number code, and optionally the name if stored on the key tag, is read from the key tag. In stage 2080 the database is queried as to whether the dwelling number code, and optionally the name, has already been stored thereon. In the event that the dwelling number code, and optionally the name, has not yet been stored in the database, in stage 2090 the dwelling number code, and optionally the name, read in stage 2070 is stored in the database, and preferably a flag is set to indicate that the dwelling number code, and optionally the name, has been stored in the database. In the event that in stage 2080 the dwelling number code read, and optionally the name, in stage 2070 has been stored in the database, or after stage 2090, in stage 2100 the key code and the date stamp and optionally the time stamp of the key code is read from the key tag.

In stage 2110, the database is queried as to whether the key code associated with the dwelling number read in stage 2070 has already been stored thereon. In the event that the key code associated with the dwelling number has been stored on the database, in stage 2120 the date stamp, and optionally the time stamp, read in stage 2100 is compared with the date stamp and optionally the time stamp associated with the key code stored in the database. In the event that the date stamp, and optionally the time stamp, of the key code read in stage 2100 is newer than the date stamp, and optionally the time stamp, of the key code stored in the database, in stage 2130 the new date stamp, and optionally the time stamp, is stored in the database associated with the key code. Thus, the new date stamp, and optionally the time stamp, replaces the previously stored date and time.

In the event that in stage 2120 the date, and optionally the time, of the key code read in stage 2100 is not newer than the date, and optionally the time, of the key code stored in the database, in stage 2140 the key tag is rejected as an unauthorized key, and preferably any information stored on the key tag is erased. Preferably, the display is set to indicate that the key tag is invalid. As described above in relation to FIG. 7, and as will be described further hereinto below, a replacement key tag is loaded with a newer date stamp, and optionally the time stamp, than a lost key tag. The date stamp, and optionally the time stamp, is thus used to invalidate key tags that have been replaced.

In the event that in stage 2110 the key code associated with the dwelling number has not been stored on the database, in stage 2150 the new date stamp, and optionally the time stamp, is stored in the database associated with the key code and dwelling number read in stages 2100 and 2070 respectively.

Thus, the routine of FIG. 8 enables restoring information to the interphone panel from the key tags, thereby utilizing the key tags as a back up storage location. As described above, in another embodiment a single transfer key tag is used, and all building information stored on the interphone panel is backed up on the transfer key tag. In such an embodiment, a single predetermined programming code followed by an extended period of proximity between the key tag reader and the transfer tag will upload all the key tag information in place of the individual key tag upload method of FIG. 8. Optionally, the key tag upload method of FIG. 8 may still be utilized for individual key tags which have not been backed up on the transfer tag.

FIG. 9 illustrates a high level flow chart of the operation of the interphone panel to control access to a multiple dwelling building, and erase information from key tags which have been replaced in accordance with a principle of the invention. In stage 3000, the interphone panel is at normal operation, enabling communication between visitors and individual dwellings via the controlled voice path.

In stage 3010 a key tag reader/encoder such as key tag reader/encoder 50 of FIG. 1 is polled to identify if a key tag has been sensed. In the event that no key tag is sensed stage 3000 is repeated. Stage 3010 may be accomplished automatically by a proximity sensor, or on a fixed time polling basis. In the event that in stage 3010 a key tag was sensed, in stage 3020 building information is read from the key tag. In stage 3030 the building information read from the key tag in stage 3020 is compared with the building information stored in a database. Preferably the database is local as described above in relation to database 140 of FIG. 2 however the database may be remotely stored without exceeding the scope of the invention.

In the event that in stage 3030 the building information read in stage 3020 does not match the building information stored in the database, in stage 3040 an error indicating unauthorized access is generated. In an exemplary embodiment the error is displayed on the interphone panel display, such as display 30 of FIG. 1. In another embodiment the error indication and the time of unauthorized access attempt are transmitted to a central server, for example via network connection 150 of FIG. 2.

In the event that in stage 3030 the building information read in stage 3020 does match the building information stored in the database, in stage 3050 a dwelling number code, and optionally a dwellant name, is read from the key tag. In stage 3060 the dwelling number code and optionally the dwellant name, read from the key tag in stage 3050 is compared with the dwelling number codes, and optionally dwellant names, stored in a database. Preferably the database is local as described above in relation to database 140 of FIG. 2 however the database may be remotely stored without exceeding the scope of the invention.

In the event that in stage 3060 the dwelling number code, and optionally the dwellant name, read in stage 3050 does not match a dwelling number code, and optionally the dwellant name, stored in the database, in optional stage 3070 an error indicating unauthorized access is generated. In an alternative embodiment, the dwelling number code and optionally the dwellant name is stored in the database. In an exemplary embodiment in which an error is generated, the error is displayed on the interphone panel display, such as display 30 of FIG. 1. In another embodiment the error indication and the time of unauthorized access attempt are transmitted to a central server, for example via network connection 150 of FIG. 2. Preferably all information on the key tag is erased by operation of the key tag encoder portion of the key tag reader/encoder. This is preferred since the key tag read in stage 3020 and 3050 has correct building information and incorrect dwelling information, thus indicating a near breach of security. In the alternative embodiment security is provided primarily by the building information, and new dwellant number codes and dwellant names are automatically loaded from the key tags by the alternative operation of stage 3070. After the alternative operation of stage 3070, stage 3080 as described below is performed.

In the event that in stage 3060 the dwelling number code, and optionally the dwellant name, read in stage 3050 matches a dwelling number code, and optionally the dwellant name, stored in the database in stage 3080 the key code and date stamp and optionally the time stamp are read from the key tag. In stage 3090 the key code read from the key tag in stage 3080 is compared with the key code information stored in a database associated with the dwelling number read in stage 3050. Preferably the database is local as described above in relation to database 140 of FIG. 2 however the database may be remotely stored without exceeding the scope of the invention.

In the event that in stage 3090 the key code information read in stage 3080 does not match the key code information associated with the dwelling number read in stage 3050 stored in the database, in stage 3100 an error indicating unauthorized access is generated, and preferably all information on the key tag is erased by operation of the key tag encoder portion of the key tag reader/encoder. This is preferred as a result of the key tag having both building information and correct dwelling information, thus indicating a near breach of security. In an exemplary embodiment the error is displayed on the interphone panel display, such as display 30 of FIG. 1. In another embodiment the error indication and the time of unauthorized access attempt are transmitted to a central server, for example via network connection 150 of FIG. 2.

In the event that in stage 3090 the key code read in stage 3080 matches the key code stored in the database associated with the dwelling number read in stage 3050, in stage 3110 the date stamp and optionally the time stamp of the key tag read in stage 3080 is compared with the date stamp and optionally the time stamp of the key code information associated with the dwelling number read in stage 3060 stored in the database. In the event that the date stamp and optionally the time stamp is more recent than the date stamp and optionally the time stamp stored in the database, in stage 3120 the date stamp and optionally the time stamp in the database is replaced with the date stamp and optionally the time stamp read from the key tag in stage 3080. The latest date stamp and optionally the time stamp is therefore stored in the database associated with the key code and dwelling number read in stages 3080, 3050 respectively. Thus, the existence of a replacement key is automatically identified by the method of the subject invention, and the database associated with the interphone panel is updated. In stage 3130 access is allowed, preferably by the operation of electronic lock 160.

In the event that in stage 3110 the date stamp and optionally the time stamp is not more recent than the date stamp and optionally the time stamp stored in the database, in stage 3140 the date stamp and optionally the time stamp of the key tag read in stage 3080 is compared with the date stamp and optionally the time stamp associated with the key code stored in the database. In the event that the date stamp and optionally the time stamp is the same as the date stamp and optionally the time stamp stored in the database, in stage 3130 access is allowed, preferably by the operation of electronic lock 160.

In the event that in stage 3140 the date stamp and optionally the time stamp is not the same as the date stamp and optionally the time stamp stored in the database, in stage 3150 an error indicating unauthorized access is generated, and preferably all information on the key tag is erased by operation of the key tag encoder portion of the key tag reader/encoder. Thus, a key tag which has been replaced with a key tag having a new date stamp and optionally time stamp is rejected due to the date stamp and optionally the time stamp, and preferably erased to prevent unauthorized use. In an exemplary embodiment the error is displayed on the interphone panel display, such as display 30 of FIG. 1. In another embodiment the error indication and the time of unauthorized access attempt are transmitted to a central server, for example via network connection 150 of FIG. 2.

Thus the present embodiments enable an interphone panel having associated therewith a controlled access proximity key tag reader/encoder. The interphone panel is further supplied with a display, and a keypad, the keypad being useable by authorized personnel to enter commands thereby encoding replacement key tags via the associated key tag encoder.

The key tags of a multiple dwelling building are preferably each encoded with dwelling number information. In one embodiment the dwelling number information comprises a numeric code corresponding to the dwelling number, and in another embodiment one or more names are associated with the dwelling and stored with the numeric code or in place of the numeric code.

Preferably, in a multiple dwelling building in which the invention is provided, each key tag belonging to a specific dwelling is provided in one of a plurality of pre-determined colors. Thus, each key tag of each specific dwelling is visibly encoded via a color. Further preferably, the colors are selected in the order of the rainbow, specifically blue, green, yellow, orange and red. In the event that additional key tags are required, a bi-color key tag having one of the above colors with a secondary color, such as grey, is provided.

Preferably, the key tags are further encoded with a date, and further preferably a time, of encoding. The access control system associates the latest date and optionally time with the replacement key tag code, thereby disabling old key tags. Further preferably, when presented with a disabled key tag, the system is operative to erase all data from the disabled key tag.

In one embodiment a transfer key tag is provided, the transfer key tag storing a complete set of information stored in the interphone pane. The transfer key tag can thus be used as a back-up for the system, or to copy all the key code and dwelling information for transfer to a management station.

In a preferred embodiment each key tag in the system is further used as a system backup, by having the building code stored thereon by the key tag encoder. Thus, in the event of a replacement of a part of the system, the system self uploads from the key tag.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. An interphone panel for a multiple dwelling building operable to control access and encode replacement keys, said interphone panel comprising:
a controller;
a proximity key tag reader/encoder responsive to said controller; and
an interphone voice path responsive to said controller, said interphone voice path creating a voice path between a user and a dweller of the multiple dwelling building,
said controller being operative to encode a proximity key tag via said proximity key tag reader/encoder with at least one of building information, dwelling information and key code information.

2. An interphone panel according to claim 1, further comprising a keypad associated with said controller, said controller being operative to encode the proximity key tag responsive to a pre-determined code entered via said keypad.

3. An interphone panel according to claim 2, further comprising an electronically controlled lock responsive to said controller, said controller allowing building access via said electronically controlled lock.

4. An interphone panel according to claim 1, further comprising a database associated with said controller, said database comprising building information, dwelling information, key code information, and date stamp information, said date stamp information being associated with said key code information, said controller being further operative to encode the proximity tag with said date stamp information.

5. An interphone panel according to claim 4, wherein said key code information is associated with a unique key color.

6. An interphone panel according to claim 5, wherein said unique key color is selected from among blue, green, yellow, orange and red.

7. An interphone panel according to claim 4, wherein said controller is further operative to read at least one of building information, dwelling information, key code information and date stamp information from a key tag sensed in proximity to said proximity key tag reader/encoder, and compare said read information with said information on said database.

8. An interphone panel according to claim 7, wherein in the event said read date stamp information is newer than said stored date stamp information, said controller is operative to replace said stored date stamp information with said read date stamp information.

9. An interphone panel according to claim 7, wherein in the event said read date stamp information is older than said stored date stamp information, said controller is operative to erase at least one of building information, dwelling information and key code information from said key tag.

10. An interphone panel according to claim 4, wherein said controller is operative to store at least one of building information, dwelling information and key code information read from at least one key tag in said database, said stored information being use to restrict access to users of key tags.

11. An interphone panel according to claim 1, wherein said dwelling information comprises one of a plurality of names associated with the dwelling.

12. A method of restricting access and encoding key tags, the method comprising:
providing an interphone panel having a proximity key tag reader/encoder; and
encoding a proximity key tag via said proximity key tag reader/encoder with at least one of building information, dwelling information and key code information.

13. A method according to claim 12, further comprising:
receiving a pre-determined code,
said encoding being responsive to said received pre-determined code.

14. A method according to claim 13, further comprising:
allowing access in response to an authorized sensed proximity key tag.

15. A method according to claim 12, further comprising:
storing building information, dwelling information, key code information, and date stamp information, said date stamp information being associated with said key code information; and
encoding the proximity key tag with said date stamp information.

16. A method according to claim 15, wherein said key code information is associated with a unique key color.

17. A method according to claim 16, wherein said unique key color is selected from among blue, green, yellow, orange and red.

18. A method according to claim 15, further comprising:
sensing a key tag in proximity to said provided proximity key tag reader/encoder;
reading at least one of building information, dwelling information, key code information and date stamp information from said sensed key tag sensed; and
comparing said read information with said stored information.

19. A method according to claim 18, further comprising in the event said read date stamp information is newer than said stored date stamp information, replacing said stored date stamp information with said read date stamp information.

20. A method according to claim 18, further comprising in the event said read date stamp information is older than said stored date stamp information, erasing at least one of building information, dwelling information and key code information from said sensed key tag.

21. A method according to claim 15, further comprising storing at least one of building information, dwelling information and key code information read from at least one key tag, said stored information being use to restrict access to users of key tags.

22. A method according to claim 12, wherein said dwelling information comprises one of a plurality of names associated with the dwelling.

23. A method of backing up an interphone panel via at least one key tag, said method comprising:
storing building information, dwelling information and key code information on a key tag;
in the event of a need to restore information from a key tag:
reading said stored building information from the key tag; and
reading said stored dwelling information from the key tag; and
in the event either of said read building information or said dwelling information has not been stored on the interphone panel;
storing at lest one of said read building information and dwelling information on said interphone panel,
whereby future key tags are authorized based on said stored information on said interphone panel.

24. A method according to claim 23, further comprising in the event of a need to restore information from a key tag:
reading said stored key code information from the key tag; and
in the event said key code information has not been stored on said interphone panel, storing said read key code information on said interphone panel, thereby allowing future access to a key tag having said stored key code information.

25. A method according to claim 24, further comprising:
in the event said key code information has been stored on said interphone panel, comparing a date stamp of said read stored key code information with said stored key code information, and in the event said date stamp of said stored key code information is older than said read stored key code information, replacing said stored key code information with said read key code information.

26. A method according to claim 25, further comprising:
in the event said date stamp of said stored key code information is newer than said read stored key code information, erasing said key code information from said key tag.

27. An interphone panel for a multiple dwelling building operable to control access and encode replacement keys, said interphone panel comprising:
a controller;
a proximity key tag reader/encoder responsive to said controller; and
a database associated with said controller, said database comprising building information, dwelling information, key code information, and date stamp information, said date stamp information being associated with said key code information, said controller being further operative to encode the proximity tag with said date stamp information.

28. An interphone panel according to claim 27, wherein said controller is further operative to:
read at least one of building information, dwelling information, key code information and date stamp information from a key tag sensed in proximity to said proximity key tag reader/encoder;
compare said read information with said information on said database; and
in the event said read date stamp information is newer than said stored date stamp information, replace said stored date stamp information with said read date stamp information; and
in the event said read date stamp information is older than said stored date stamp information, erase at least one of building information, dwelling information and key code information from said key tag.
